(19) United States
(12) Patent Application Publication
(10) Pub. No.: US 2002/0152146 A1
(43) Pub. Date: Oct. 17, 2002

(54) Method and apparatus for identifying patent licensing targets

(76) Inventor: Scot A. Reader, Sherman Oaks, CA (US)

Correspondence Address: Scot A. Reader, Esq., 3424 Woodcliff Road, Sherman Oaks, CA, 91403, US

(21) Appl. No.: 09/835,915

(22) Filed: Apr. 16, 2001

(51) Int. Cl. G06F 17/60

(52) U.S. Cl. 705/35

(57) ABSTRACT

The present invention facilitates identification of candidate and qualified patent licensing targets through the expedient of assessing technological overlap between patent assets of the licensing entity and third party entities. By using third party patenting activity to drawn inferences about third party business activity, the invention allows a threshold identification of third parties as candidate licensing targets to be made and a further identification of candidate licensing targets as qualified licensing targets to be made without requiring any direct knowledge concerning third party business activity. Moreover, the present invention may be applied in a networked computing environment to allow such identifications to be made with relatively small cost and time commitment.

### BACKGROUND OF THE INVENTION

Companies are increasingly tapping their patent portfolios for revenues. The typical revenue stream comes from license fees collected from third parties who practice under the patents. The first step toward collecting license fees is identifying third parties who are good candidates for practicing under the patents, i.e. qualified licensing targets.

A company may face numerous obstacles in identifying qualified licensing targets. A first obstacle may be making a threshold identification of third parties worth investigating, i.e. candidate licensing targets. A second obstacle may be lack of relevant data concerning product and service offerings of candidate licensing targets. A third obstacle may be a lack of adequate automation to apply such data. That is, even if one succeeds reasonably well in identifying candidate licensing targets and in acquiring relevant data concerning their product and service offerings, there is a considerable cost and time investment required to apply such data to determine whether they are qualified licensing targets. The additional cost and time investment is particularly significant if the population of candidate licensing targets is large.

These obstacles can cloud judgments as to which third parties to pursue, in what order to pursue them and what offers to make to them.

### SUMMARY OF THE INVENTION

The present invention facilitates a licensing entity's identification of candidate and qualified licensing targets through the expedient of assessing technological overlap between the patent assets of the licensing entity and third party entities. The invention uses third party patenting activities to draw inferences about third party business activities, allowing a threshold identification of third parties as candidate licensing targets to be made and a further identification of candidate licensing targets as qualified licensing targets to be made without requiring any direct knowledge of third party business activity. Moreover, the present invention may be applied in a networked computing environment to allow such identifications to be made with relatively little cost and time commitment.

A method in accordance with the present invention comprises: identifying a first entity; and comparing in a first instance patent assets of the first entity and patent assets of a second entity for first technological overlap, wherein the second entity is identified or not as a candidate licensing target in function of the result of the comparison in the first instance.

Another method in accordance with the present invention comprises: identifying a first entity; and comparing in a second instance patent assets of the first entity and patent assets of a second entity for second technological overlap, wherein the second entity is identified or not as a qualified licensing target in function of the result of the comparison in the second instance.

Another method in accordance with the present invention comprises: identifying a first entity; identifying one or more classes in which a first entity has patent assets; identifying or not a second entity as a licensing target in function of a determination of patent assets the second entity has in the one or more classes.

Another method in accordance with the present invention comprises: identifying a first entity and an overlap threshold; and identifying or not a second entity as a licensing target in function of the result of a comparison of an overlap factor with the overlap threshold, wherein the overlap factor is calculated based on technological overlap between patent assets of the first entity and patent assets of the second entity.

Another method in accordance with the present invention comprises: identifying a first entity; and identifying or not a second entity as a licensing target in function of a comparison of patent assets of the first entity and patent assets of the second entity for technological overlap.

A networked computing system in accordance with the present invention comprises: an end-user station having a user interface, for interacting with a user, and a network interface, for interacting with a network, wherein the end-user station interacts with the network to identify a licensing target in response to identification of a licensing entity from an interaction involving the user.

These and other objects of the present invention may be better understood by reference to the following detailed description, taken in conjunction with the accompanying drawings briefly described below. Of course, the actual scope of the invention is defined by the appended claims.

### BRIEF DESCRIPTION OF THE DRAWINGS

FIG. 1 illustrates a networked computing environment for use in identifying licensing targets; and

FIG. 2 is a flow diagram illustrating a method for identifying licensing targets.

### DETAILED DESCRIPTION OF THE PREFERRED EMBODIMENT

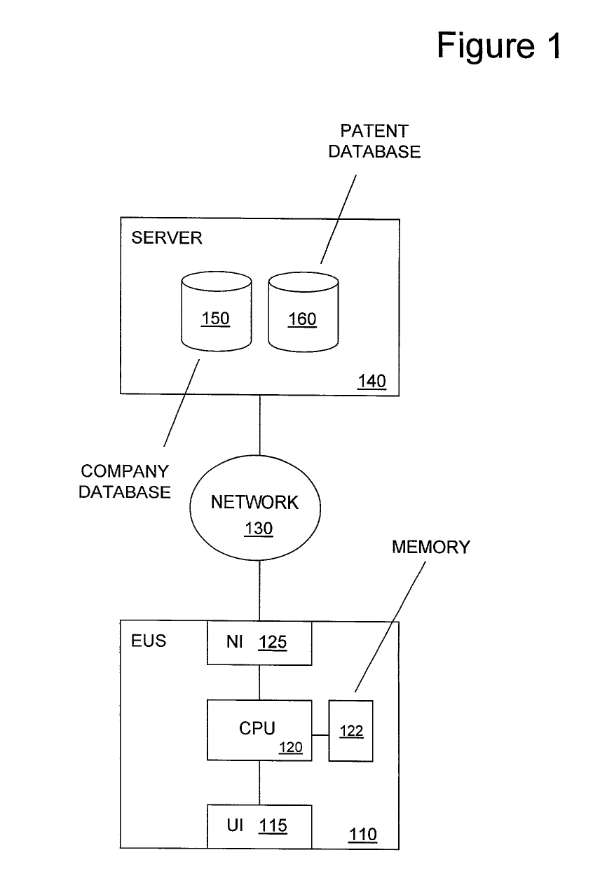

In FIG. 1, a networked computing environment for use in automated identification of licensing targets is shown. The environment includes end-user station (EUS) 110, such as a personal computer or workstation, having user interface 115, processor (CPU) 120, memory 122 and network interface (NI) 125. End-user station 110 receives and transmits data on user interface 115, processes data, in conjunction with memory 122, using processor 120 and exchanges data with server 140 over network interface 125. Data exchanges are performed via network 130, such as a LAN or WAN, and involve retrieving information from company database 150 and patent database 160. Memory 122 stores data. including software program instructions and data retrieved in data exchanges. Such stored data are used by processor 12n to provide functionality described herein as being performed by processor 120. Company database 150 has entries for companies that include names of their affiliated companies. Patent database 160 has entries for patents that include patent numbers, assignee names, filing dates, grant dates, maintenance status data and patent classification numbers. Patent classification numbers may include international classification numbers or U.S. classification numbers, or both. It will be appreciated that patent classification numbers represent technological fields of patents. The entries for patents may include full-text patents. Server 140 may, in addition to databases 150, 160, include processing elements applied, for instance, in interacting with databases 150, 160 to facilitate generation of search results for search queries received from end-user station 110. Of course, databases 150, 160 may in other embodiments of the invention reside on different servers.

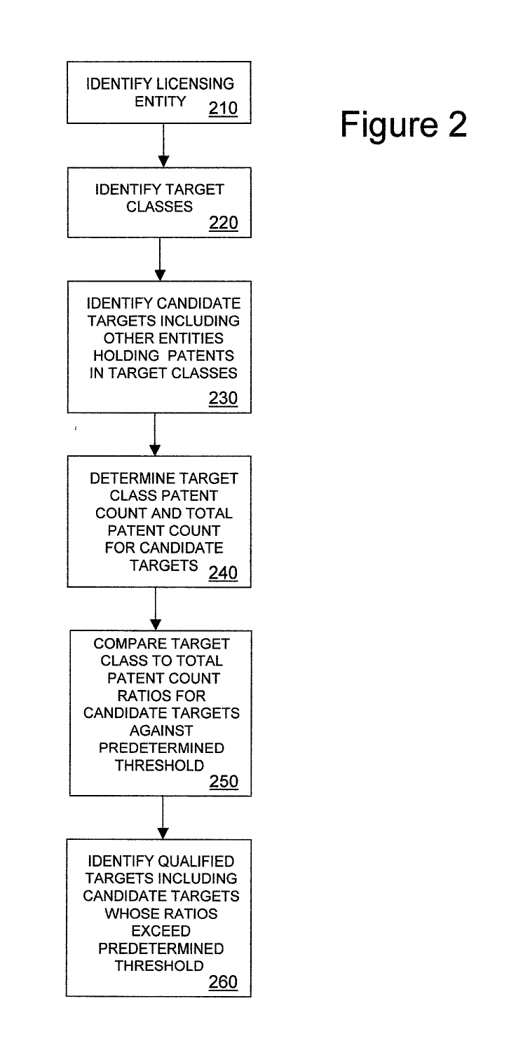

In FIG. 2, a flow diagram illustrates a method for identifying licensing targets in accordance with the invention. As applied within the networked computing environment of FIG. 1, a user of end-user station 110 identifies a company as a licensing entity. The identification may include an official corporate name or a shorthand name of a company, and may be made, for example, by selection from a pull-down menu or keystroke input. Processor 120 forms a licensing entity affiliate search query including as a search attribute the licensing entity identity. The licensing entity affiliate search query is transmitted over network 130 from end-user station 110 to server 140 via network interface 125. At server 140, the attribute from the licensing entity affiliate search query is applied to company database 150 to generate a licensing entity affiliate search result including the official corporate names of companies affiliated with the licensing entity identity, which may include, for instance, the legal names of company intended to be identified by the licensing entity identity (if any) and other companies under common control therewith. The licensing entity affiliate search result is transmitted from server 140 to end-user station 110 via network 130 and interface 125. Step 210 is thereby completed. Of course, identifying a licensing entity may be accomplished without consultation of company database 150 through direct user input of the official corporate names of affiliated companies comprising the licensing entity.

At end-user station 110, processor 120 forms a target class search query including as search attributes the official corporate names from the licensing entity affiliate search result. The target class search query is transmitted from end-user station 110 to server 140 via network 130 and interface 125. At server 140, attributes from the target class search query are applied to patent database 160 to generate a target class search result, including patent classifications from the patents on which any of the official corporate names are the named assignee. Such patent classifications are hereinafter often referenced as “target” classifications or “target” classes. The target class search result is transmitted from server 140 to end-user station 110 via network 130 and interface 125. Step 220 is thereby completed.

It will be appreciated that, at this point in the process, identities of patent classifications in which a properly defined licensing entity owns or controls patent assets have been learned.

At end-user station 110, processor 120 stores the target classifications from the target class search result in memory 122 for later reference and forms a candidate target search query including the target classifications as search attributes. The candidate target search query is transmitted from end-user station 110 to server 140 via network 130 and interface 125. At server 140, attributes from the candidate target search query are applied to patent database 160 to generate a candidate target search result, including the assignees named on patents within any of the target classifications. The candidate target search result is transmitted from server 140 to end-user station 110 via network 130 and interface 125. Processor 120 checks for and discards duplicate instances of assignees (e.g. redundant instances of assignees reported multiple times due to being named on two or more patents within a target classification). Processor 120 forms a candidate target affiliate search query including as a search attribute the remaining named assignees from the candidate target search result and the candidate target affiliate search query is transmitted over network 130 from end-user station 110 to server 140 via interface 125. At server 140, the attribute from the candidate target affiliate search query is applied to company database 150 to generate a candidate target affiliate search result, including families of official corporate names of companies affiliated with the named assignees from the candidate target search result. Step 230 is thereby completed.

It will be appreciated that, at this point in the process; identities of candidate licensing targets have been learned, wherein each candidate licensing target is a single company or a family of companies under common control owning patent assets in at least one classification in which the licensing entity also owns patent assets.

The candidate target affiliate search result is transmitted from server 140 to end-user station 110 via network 130 and interface 125. At end-user station 110, processor 120 checks for and discards duplicate instances of candidate licensing target identities (e.g. redundant instances of identities reported multiple times due to two or more different named assignees that are part of the same family of companies having been applied in the candidate target affiliate search query). Processor 120 retrieves the target classifications from memory 122 and forms a patent count search query including as search attributes the remaining candidate licensing target identities and the target classifications. The patent count search query is transmitted from end-user station 110 to server 140 via search query are applied to patent database 160 to generate a patent count search result including, for each candidate licensing target, a patent count within the target classifications and a total patent count. In this regard, the total patent count for a candidate licensing target is the sum of the patents on which one of the official corporate names comprising the candidate licensing target identity is the named assignee. The target patent count for the candidate licensing target is the sum of the patents on which, in addition to an assignee match, a patent classification listed on the patent is a target classification. The patent count search result is transmitted from server 140 to end-user station 110 via network 130 and interface 125. Step 240 is thereby completed.

It will be appreciated that, at this point in the process, patent counts for the candidate licensing targets concerning both patent assets held in the target classifications and overall have been learned.

At end-user station 110, processor 120 calculates for each candidate licensing target an overlap factor by dividing the target patent count for the candidate licensing target by the total patent count for the candidate licensing target. Processor 120 compares for each candidate licensing target the overlap factor with an overlap threshold from memory 122 to identify qualified licensing targets from among the candidate licensing targets. That is, candidate licensing targets for which the overlap factor meets or exceeds the overlap threshold are identified as qualified licensing targets. Candidate licensing targets for which the overlap factor does not meet or exceed the overlap threshold are not identified as qualified licensing targets. The overlap threshold is a value between zero and one (i.e. 0% and 100%) that may be selected by the user, for example, by selection from a pull-down menu or keystroke input. It will be appreciated that higher values selected by the user will impose a stricter definition of qualified licensing target whereas lower values will impose a looser definition of qualified licensing target. A value of zero will impose the loosest definition of qualified licensing target, that is, a definition under which all candidate licensing targets would qualify and may be used as a default. Step 250 is thereby completed. Of course, technological overlap may be defined in relation to technological criteria other than patent classifications. Moreover, technological overlap may be defined in relation to overlap criteria other than percentages of patents meeting the technological criteria. Moreover, technological overlap may be one of a plurality of criteria used in identifying licensing targets. Other criteria used in conjunction with technological overlap may include, for instance, revenue thresholds.

It will be appreciated that, at this point in the process, identities of qualified licensing targets have been learned, wherein each qualified licensing target is a single company or a family of companies under common control whose patent assets have sufficient technological overlap with those of the licensing entity in accordance with a user selectable overlap threshold.

The identities of the qualified licensing targets may be output to a user of end-user station 110 via user interface 115. Alternatively, end-user station 110 may apply the qualified licensing target identities in further interaction with server 140 via network 130 to determine patent license fee data for output to a user of end-user station 110. A suitable apparatus and method for determining patent license fee data is described in U.S. patent application Ser. No. 09/752,471 entitled “METHOD AND APPARATUS FOR DETERMINING PATENT LICENSE FEES”, which has common inventorship with the present invention and is incorporated herein by reference.

It will be appreciated by those of ordinary skill in the art that the present invention can be embodied in other specific forms without departing form the spirit or essential character hereof. The present description is therefore considered in all respects illustrative and not restrictive. The scope of the invention is indicated by the appended claims, and all changes that come within the meaning and range of equivalents thereof are intended to be embraced therein.

I claim:

1. A method for identifying patent licensing targets, comprising:
identifying a first entity;
identifying one or more classes in which the first entity has patent assets;
identifying or not a second entity as a licensing target in function of a determination of patent assets the second entity has in the one or more classes.

2. The method of claim 1, wherein the method is performed in a networked computing environment.

3. The method of claim 1, wherein the third identifying step includes identifying or not the second entity as a licensing target in function of whether or not, respectively, the second entity has patent assets in the one or more classes.

4. The method of claim 1, wherein the third identifying step includes identifying or not the second entity as a licensing target in function of whether or not, respectively, the second entity has at least a user determined threshold of patent assets in the one or more classes.

5. The method of claim 1, wherein the first and second entities include respective families of affiliated companies.

6. A method for identifying patent licensing targets, comprising:
identifying a first entity and an overlap threshold; and
identifying or not a second entity as a licensing target in function of the result of a comparison of an overlap factor with the overlap threshold, wherein the overlap factor is calculated in function of technological overlap between patent assets of the first entity and patent assets of the second entity.

7. The method of claim 6, wherein the technological overlap is defined in function of the number of patents owned by the second entity having a patent classification common to a patent owned by the first entity.

8. The method of claim 6, wherein the technological overlap is defined in function of the percentage of patents owned by the second entity having a patent classification common to a patent owned by the first entity.

9. A method for identifying patent licensing targets, comprising:
identifying a first entity; and
identifying or not a second entity as a licensing target in function of a comparison of patent assets of the first entity and patent assets of the second entity for technological overlap.

10. The method of claim 9, wherein the method is performed in a networked computing environment.

11. The method of claim 9, wherein the second entity is identified as a licensing target if the comparison indicates at least a predetermined threshold of technological overlap, and is not identified as a licensing target if the comparison indicates less than the predetermined threshold of technological overlap, wherein the predetermined threshold is user determinable.

12. A method for identifying patent licensing targets, comprising:
identifying a first entity;
comparing in a first instance patent assets of the first entity and patent assets of a second entity for first technological overlap;
identifying or not the second entity as a candidate licensing target in function of the result of the comparison in the first instance;
comparing in a second instance patent assets of the first entity and patent assets of the second entity for second technological overlap; and
identifying or not the second entity as a qualified licensing target in function of the result of the comparison in the second instance.

13. The method of claim 12, wherein the second technological overlap is greater than the first technological overlap.

14. The method of claim 12, wherein the first entity includes a family of affiliated companies.

15. The method of claim 12, wherein the second entity includes a family of affiliated companies.

16. A networked computing system for identifying patent licensing targets, comprising:
an end-user station having a user interface, for interacting with a user, and a network interface, for interacting with a network,
wherein the end-user station interacts with the network to identify a licensing target in response to identification of a licensing entity from an interaction involving the user.

17. The system of claim 16, wherein an identity of the licensing target is output on the user interface.

18. The system of claim 16, wherein the end-user station further interacts with the network to determine patent license fee data in response to the identification of the licensing target.

19. The system of claim 16, wherein identification of the licensing entity further involves an interaction with the network.

20. The system of claim 16, wherein a plurality of licensing targets are identified in response to identification of the licensing entity from the interaction involving the user.
